(19) United States
(12) Patent Application Publication
(10) Pub. No.: US 2003/0119384 A1
(43) Pub. Date: Jun. 26, 2003

(54) Method and apparatus for automatically organizing wires of a cable

(76) Inventor: Guo-Hui Zhang, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/137,987

(22) Filed: May 2, 2002

(30) Foreign Application Priority Data
Dec. 26, 2001 (TW) 90132402

(51) Int. Cl. H01R 9/22

(52) U.S. Cl. 439/894

(57) ABSTRACT

An automatic wire organizing apparatus for organizing wires (20) of a cable (2) in a predetermined pattern, comprises an organizing device (1) defining a plurality of slots (11) therein. The apparatus further includes a motor (B), a programmed controller (A), a pick-up device (3), a transport device (5, 6) and a conductive cutting blade (4) electrically connected to the controller. The wires of the cable are lined up in the slots of the wire organizing device by the following steps: (i) The pick-up device moves to an exposed second end of the cable and pick up one of the wires; (ii) The conductive member contacts with an inner conductor of the picked wire to form a closed circuit with a checkout equipment (D) connecting with a first end of the wires of the cable, whereby a wire identification signal is generated and sent to the checkout equipment; and (iii) according to the wire identification signal, the motor drives the transport device to transfer the picked wire to a corresponding slot of the wire organizing device.

### BACKGROUND OF THE INVENTION

1. Field of the Invention

The present invention relates to an automatic organizing wires method and apparatus, and more particularly to a method and apparatus for automatically organizing and connecting wires of a cable to an electrical connector.

2. Description of the Related Art

Connection of a cable having a number of conductive wires to an electrical connector is often done by Insulation Displacement Connection (IDC) technique. When the number of the conductive wires is large, sequentially organizing the conductive wires in a line in a predetermined sequence is required before the wires are connected to the connector.

FIG. 1 of the attached drawings shows a conventional wire organizing device 1 which comprises a block defining a plurality of slots 11 in a major surface thereof and a rectangular inner section 12 that is removably received in an opening defined in the block. Each conductive wire of the cable (not shown in FIG. 1) is manually settled in a corresponding slot 11 of the wire organizing device 1 and retained therein. The inner section 12 is removed from the wire organizing device 1 and replaced by a connector with IDC type conductive contacts. The conductive contacts pierce through insulations of the conductive wires to thereby electrically connect therewith. Conventionally, the conductive wires are manually placed in the corresponding slots by visually identifying different colors of the wires. This method is time inefficient and labor consuming. The productivity is limited. Hence, it is necessary to organize the conductive wires of the cable in an automatic fashion prior to the connection of the cable to an electrical connector.

### SUMMARY OF THE INVENTION

Accordingly, it is an object of the present invention to provide a method for automatically organizing wires of a cable before connecting the cable to an electrical connector.

It is another object of the present invention to provide an apparatus for automatically organizing wires of a cable before connecting the cable to an electrical connector.

To achieve the above objects, an apparatus for automatically organizing a plurality of conductive wires of a cable to a plurality of corresponding slots defined in a major surface of a wire organizing device comprises a programmed controller controlling a motor for driving a pick-up device and a transport device, and a checkout equipment to which a first end of the cable is attached. A method for operating the apparatus to organizing the wires comprises the following steps: (1) Moving the pick-up device to an exposed end of the cable and having the pick-up device to pick up an arbitrary one of the wires; (2) having a conductive member to cut through an insulation of the picked wire and contact with an inner conductor of the wire to form a closed circuit with the checkout equipment, whereby a wire identification signal is generated and sent to the checkout equipment; and (3) according to the wire identification signal, driving the motor to activate the transport device to move the picked wire to a corresponding slot of the wire organizing device.

Other objects, advantages and novel features of the invention will become more apparent from the following detailed description of the preferred embodiment thereof when taken in conjunction with the accompanying drawings, wherein:

### BRIEF DESCRIPTION OF THE DRAWINGS

FIG. 1 is a perspective view of a conventional wire organizing device;

FIG. 2 is a schematic view of an apparatus in accordance with the present invention for automatically organizing the wires of the cable;

FIG. 2A is an enlarged view of a circled portion 2A of FIG. 2; and

FIG. 2B is an enlarged view of a circled portion 2B of FIG. 2.

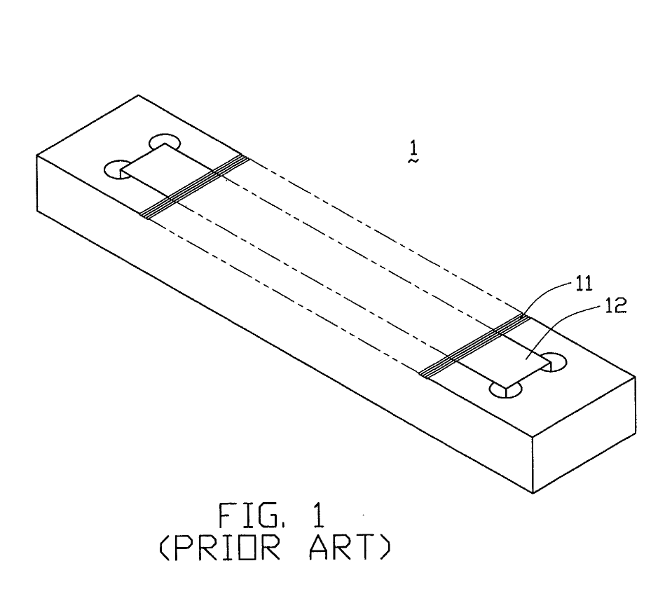

### DETAILED DESCRIPTION OF PREFERRED EMBODIMENTS

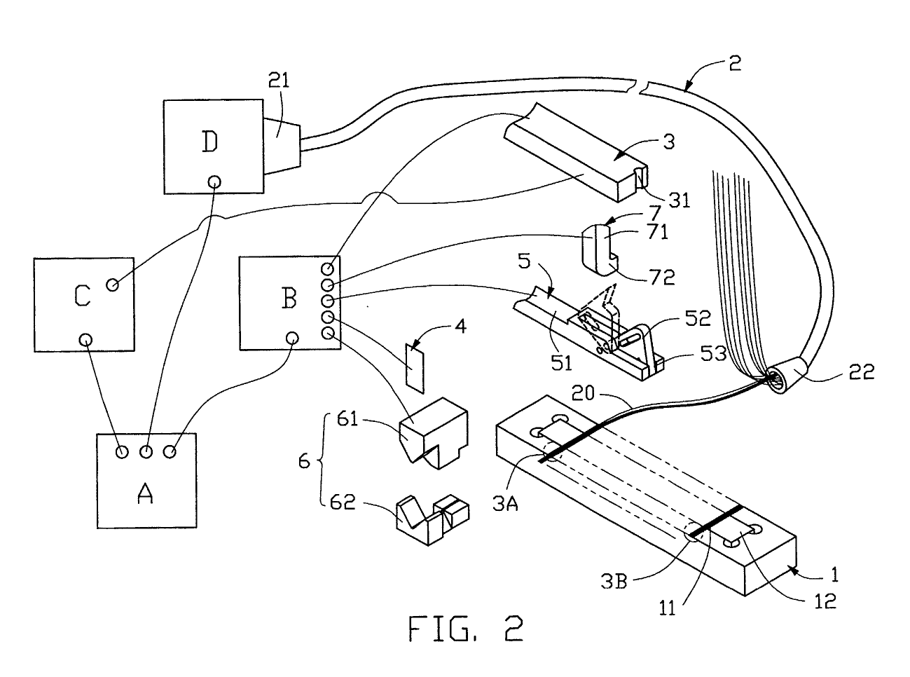

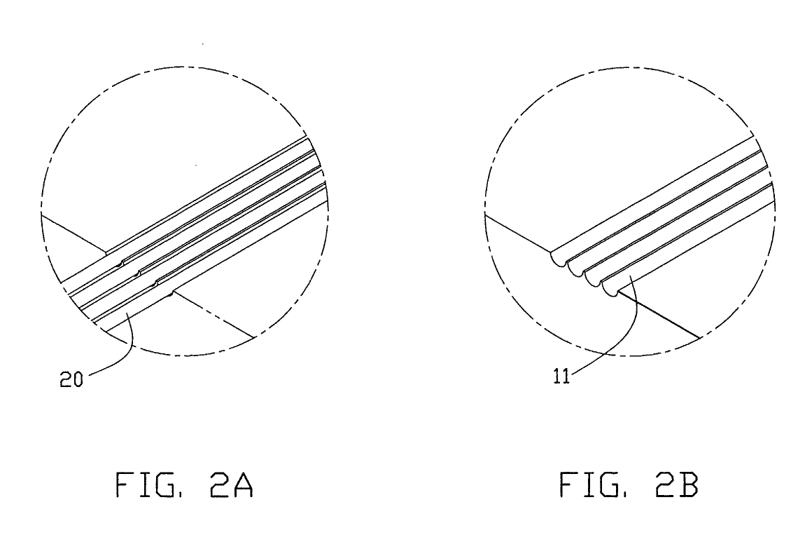

Referring to FIGS. 2, 2A and 2B, an automatic wire organizing apparatus in accordance with the present invention comprises a motor B, a programmed controller A, an encoding device C, a checkout equipment D, a pick-up device 3, a conductive cutting blade 4 having a sharp edge, a transport device comprising a first supporting device 5 and a second supporting device 6, and a press device 7. Illustratively, the motor B is a step motor and the programmed controller A is a PLC (Programmable Logic Control) device. A groove 31 is defined in one end of the pick-up device 3, and a sensor (not shown) is fixed in the grooved 31 of the pick-up device 3. The first supporting device 5 comprises a body section 51 with a slot 53 formed at one end of the body section 51 and a pawl 52. The pawl 52 is partially received in the slot 53 and pivotally connected to the body section 51 whereby the pawl 52 can rotate about the pivotal connection to enter and leave the slot 53. The second supporting device 6 comprises a pair of clip masses 61, 62 engagable with each other. The press device 7 comprises a vertical section 71 and a press section 72 perpendicularly connected to a bottom of the vertical section 71. The encoding device C is electrically connected to the sensor of the pick-up device 3 and the controller A for processing signals induced by the sensor and applying the processed signals to the controller A. The controller A is electrically connected to the motor B for controlling the movement of the motor B. The pick-up device 3, the cutting blade 4, the transport device 5, 6, and the press device 7 are respectively drivably connected with the motor B. The controller A issues control signals to the motor B, which in turn drives the pick-up device 3, the cutting blade 4, the transport device 5, 6 and the press device 7 to move according the control signals. The automatic wire organizing device also comprises a wire organizing device 1 having a block defining a plurality of slots 11 in its upper face, and a rectangular inner section 12 removably received in an opening defined in the block.

A method for using the apparatus in accordance with the present invention for automatically organizing wires of a cable comprises the following steps:

(1) Connecting a first end 21 of a cable 2 to the checkout equipment D, in which every wire 20 of the cable 2 is electrically connected with the checkout equipment D in accordance with a predetermined pattern;

(2) Removing a jacket (not labeled) of the cable 2 at a second end 22 of the cable 2 to expose the wires 20, and then brushing the wires 20 to separate from each other in a vertical direction;

(3) Moving the pick-up device 3 toward the wires 20 at the second end 22 and picks up one of the wires 20 in which the picked wire 20 is received in the groove 31 so that the sensor of the pick-up device 3 can determine that a wire is in the groove 31 and send the signal to the encoding device C informing such a conduction;

(4) The encoding device C encoding the signal into a code, and sending the code to the controller A, which in turn operates the motor B;

(5) The motor B driving the pick-up device 3, and the first and second supporting devices 5, 6 in which the pick-up device 3 moves the picked wire 20 away from the remaining wires 20 to reach the first supporting device 5; the pawl 52 of the first supporting device 5 being then moved to clamp the picked wire 20 and then transferred it to the second supporting device 6 wherein the picked wire 20 is further secured by the clip masses 61, 62 which are moved toward each other;

(6) The pawl 52 of the first supporting device 5 releases the wire 20 and the first supporting device 5 moves back to its original position and then clamps the picked wire 20 again whereby the picked wire 20 is clamped by both the first and second supporting device 5, 6 with the supporting devices 5, 6 separated from each other. The cutting blade 4 being driven by the motor B to cut through the insulation of the picked wire 20 and contact with an inner conductor (not shown) of the wire 20 to form a closed circuit with the checkout equipment D;

(7) The checkout equipment D identifying the picked wire 20 by obtaining a wire identification signal through the closed circuit and sending the signal to the controller A which determines a corresponding slot 11 of the wire organizing device 1 where the picked wire 20 is to be positioned;

(8) The controller A actuating the motor B to move the first and second supporting devices 5, 6 together with the picked wire 20 toward the corresponding slot 11 of the wire organizing device 1;

(9) The motor B driving the press device 7 to reciprocally move along the wire organizing device 1 to forcibly fit the picked wire 20 into the corresponding slot 11; and

(10) The pick-up device 3, the first and second supporting devices 5, 6 and the press device 7 being then moved back to their initial positions after the picked wire 20 is retained in the corresponding slot 11.

The above steps are repeated for picking up and fitting next wire 20 in a suitable slot 1 of the wire organizing device 1.

It is to be understood, however, that even thought characteristics and advantages of the present invention have been set forth in the foregoing description, together with details of the structure and function of the preferred embodiment of the invention, the disclosure is illustrative only, and changes may be made in detail, especially in matters of shape, size, and arrangement of parts within the principles of the invention to the full extent indicated by the board general meaning of the terms in which the appended claims are expressed.

What is claimed is:

1. A method for organizing a plurality of conductive wires of a cable in a plurality of corresponding slots of a wire organizing device, comprising the following steps of:
(1) connecting a first end of the cable to a control assembly;
(2) exposing the wires at a second end of the cable and brushing the exposed wires to separate from each other;
(3) picking up an arbitrary one of the wires with a pick-up device that is drivably connected to the control assembly;
(4) moving the pick-up device to transfer the picked wire to a transport device drivably connected with the control assembly in which the picked wire is securely carried by the transport device;
(5) electrically connecting the picked wire with a conductive member that is electrically connected with the control assembly, whereby a closed circuit is formed by the picked wire, the control assembly and the conductive member so that the control assembly can identify the picked wire;
(6) the control assembly driving the transport device to move the picked wire to a corresponding slot of the wire organizing device; and
(7) repeating steps (3)-(6) for organizing another one of the wires until all of the wires are positioned in the corresponding slots of the wire organizing device.

2. The method as claimed in claim 1, wherein the control assembly comprises an encoding device electrically connected to a sensor of the pick-up device for encoding a signal from the sensor indicating that the picked wire is picked up by the pick-up device, a programmed controller for processing the encoded signal, a checkout equipment connected to a first end of the conductive wires for identifying the picked wire, and a motor to drive the pick-up device, the transport device and the conductive member.

3. The method as claimed in claim 1, wherein the pick-up device comprises a fork defining a groove for receiving the picked wire therein, and a sensor is settled in the groove.

4. The method as claimed in claim 1, wherein the transport device comprises a first supporting device and a second supporting device, the first supporting device comprising a body section with a slot defined at one end of the body section and a pawl received in the slot and pivotally connected to the body section whereby the pawl is rotatable about the pivotal connection, the second supporting device comprising a pair of clip masses which are engagable with each other.

5. The method as claimed in claim 1 further comprising a step between steps (6) and (7): forcing the wire into the slot of the wire organizing device by a press device.

6. An apparatus for automatically organizing a plurality of conductive wires of a cable in a plurality of slots of a wire organizing device, the apparatus comprising:
a control assembly;
a pick-up device connected to and controlled by the control assembly to pick up an arbitrary one of the wires;
a transport device connected to and controlled by the control assembly for transferring the picked wire; and
a conductive member for electrically connecting with the picked wire for forming a closed circuit with the control assembly whereby a first signal is generated through the closed circuit and sent to the control assembly, wherein the transport device is controlled by the control assembly to move the picked wire to a corresponding slot of the wire organizing device based on the first signal.

7. The apparatus as claimed in claim 6, wherein the pick-up device comprises a fork defining a groove for receiving the picked wire and a sensor settled in the groove.

8. The apparatus as claimed in claim 6, wherein the control assembly comprises an encoding device electrically connected to the sensor of the pick-up device, the sensor generating a second signal when the picked wire is picked up by the picked-up device, a programmed controller for encoding the second signal induced by the sensor, a checkout equipment connected to a first end of the conductive wires for identifying the picked wire by means of the first signal, and a motor for drive the pick-up device, the transport device and the conductive member.

9. The apparatus as claimed in claim 6, wherein the transport device comprises a first supporting device and a second supporting device, the first supporting device comprising a body section with a receiving slot defined at one end of the body section and a pawl received in the slot and pivotally connected to the body section whereby the pawl is rotatable about the pivotal connection, the second supporting device comprising a pair of clip masses which are engagable with each other.

10. A method of automatically locating wires of a cable into corresponding suitable slots in a wire organizer device which is used for having the discrete wires respectively connected to a plurality of contacts of a connector without through a color or numerical identification process manually, comprising the steps of:
(1) electrically connecting each of the wires of the cable to a checkout device around one end of said cable;
(2) exposing each of the wires of the cable at the other end of the cable;
(3) selecting one of the wire;
(4) forming a circuit loop between the selected one of the wires and said checkout to identify said selected one of the wires;
(5) predetermining positions of said wires in the slots corresponding to identifications of the wires; and
(6) disposing the selected one of the wires into the corresponding slot according to the identification of said selected one of the wires.

11. The method as claimed in claim 10, further including step (7) repeating steps (1) to (6).

12. The method as claimed in claim 10, wherein a controller and a motor are provided to move the selected one of the wires to the corresponding slot according to identification information of said selected one of the wires.

13. The method as claimed in claim 12, wherein said controller is electrically connected to said checkout device and said motor, respectively.

14. The method as claimed in claim 10,wherein said connector is an IDC type connector.

15. The method as claimed in claim 10, wherein step (5) is done also corresponding to positions of the contacts of said connector.
